(19) United States
(12) Patent Application Publication
(10) Pub. No.: US 2009/0244100 A1
(43) Pub. Date: Oct. 1, 2009

(54) Gradually changing perspective map

(76) Inventors: William C. Schwegler, San Jose, CA (US); Richard F. Poppen, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/384,337

(22) Filed: Apr. 1, 2009

Related U.S. Application Data
(60) Provisional application No. 61/041,594, filed on Apr. 1, 2008.

(51) Int. Cl. G09G 5/14

(52) U.S. Cl. 345/668

(57) ABSTRACT

Display of digital maps with gradually changing perspective is provided. A perspective engine selects from among possible foreshortening ratios depending on the selected map scale. In one embodiment, the perspective engine uses a fixed perspective view corresponding to each of a fixed set of scales. In alternative embodiments, there is a continuum of scales, and parameters are specified as functions of the scale, rather than as fixed values. In general, at smaller scales—that is, more zoomed-out—the displayed perspective appears to be more flat, as though looking straight down at the map. At larger scales—more zoomed-in—the map is displayed with increasing perspective. In some embodiments, once a threshold scale is reached, continuing to zoom in does not additionally increase the perspective; similarly, once a threshold zoomed-out scale is reached, the map continues to be displayed in a two-dimensional flat appearance.

### CROSS-REFERENCE TO RELATED APPLICATIONS

This application claims the benefit of U.S. Provisional Application 61/041,594, filed on Apr. 1, 2008, incorporated by reference herein in its entirety.

### BACKGROUND

1. Field of the Invention

The present invention relates generally to display of maps in a user interface of a navigation system. In particular, the present invention is directed to providing varying perspective views of displayed maps according to the scale of the displayed map.

2. Description of the Related Art

Navigation systems are popularly used to guide travelers to destinations. Such systems are available built into vehicles or free-standing, to be moved from vehicle to vehicle; for use by drivers and/or pedestrians; as purpose-built devices or as applications on general-purpose devices such as personal digital assistants or mobile telephones; and as systems that are entirely self-contained or as systems that utilize a remote server to perform some or all of their calculations. We refer generally to these systems as “navigation systems.”

The designer of the user interface of a navigation system has a choice of many styles for map displays. For example, there is great variation in the choice of colors and line styles. Maps can be more or less detailed; that is, there may be a large number of features drawn in a map, or only the most important features. Separately, maps can be rendered at a variety of scales, from very large (very zoomed-in) scales, showing a map only a few tens or hundreds of meters across, to very small (very zoomed-out) scales, showing a whole country or continent on a single screen. On a given device, the user can typically select from a number of map scales. A map may be shown with north at the top of the display, so that the map looks similar to a map printed in an atlas, or it may be oriented with the traveler's current heading toward the top of the display, so that objects ahead of the traveler are above the traveler's location on the map, and so that objects to the left and right of the traveler are on the left and right sides of the map. The latter type of display is described in U.S. Pat. No. 4,914,605, incorporated by reference herein in its entirety.

Another choice the designer of a user interface makes is between a two-dimensional display and a perspective view. By a two-dimensional display we mean the type of map typically seen in an atlas or in a paper map of roads, namely, a representation presented as though the viewer of the map were directly over the area depicted and were looking straight down at the earth. A perspective view, by comparison, represents the view as seen by an imaginary viewer some distance above the earth and looking, not straight down, but rather at the horizon or else toward some other point not directly below the viewer. This type of display is described in U.S. Pat. No. 5,161,886, incorporated by reference herein in its entirety. The perspective view may be derived from truly three-dimensional data, so that the vertical dimension is represented accurately in the view. More often, the perspective view is effectively a perspective view of a flat map. That is, the perspective view is not a view that would be seen by a hypothetical viewer above actual terrain with varying elevations, but rather the view seen by a hypothetical viewer above a map which has been rendered as a straight-down view. (The latter is sometimes called a “2½-dimensional view”.) Navigation systems that offer a perspective view typically offer the same perspective at different scales. That is, the map is in effect rendered by rendering the map in various scales and orientations as a flat map, then producing a perspective view of that map, always from the same perspective.

It should be noted that in a perspective view, the scale varies from the foreground (the bottom of the image) to the background (the top of the image). The foreground of the map is necessarily more large-scale (zoomed in) than the background. As a result, if one is comparing a two-dimensional (straight-down) map at a given scale with a perspective view that has the same scale in the foreground, the perspective map will show features from a larger area of the earth because of the smaller scale in the background part of the view.

In navigation systems that offer perspective views, the user is often given a choice between a perspective view and a two-dimensional (straight-down) display. In some systems, display of very small-scale (zoomed-out) views requires more computation time or more input/output time than display of larger-scale (more zoomed-in) views. For this reason, in combination with the fact that perspective views inherently require retrieving data from a larger area of the map, some navigation systems offer perspective views only at the more large-scale (zoomed-in) view levels, and allow only two-dimensional (straight-down) displays at the smallest-scale (most zoomed-out) levels.

### SUMMARY

The present invention enables display of a digital map with gradually changing perspective. Digital map data is stored in a database of a navigation system, which may be a self-contained device, or a networked client-server system. In one embodiment the navigation system includes an optional radio for determining its current position. A perspective engine determines a perspective with which a requested map should be rendered, and then renders the map in that perspective. The rendered map is then displayed in a user interface.

Perspective engine selects from among possible foreshortening ratios depending on the selected map scale. In one embodiment, the perspective engine uses a fixed perspective view corresponding to each of a fixed set of scales. In alternative embodiments, there is a continuum of scales, and parameters are specified as functions of the scale, rather than as fixed values. In general, at smaller scales—that is, more zoomed-out—the displayed perspective appears to be more flat, as though looking straight down at the map. At larger scales—more zoomed-in—the map is displayed with increasing perspective. In some embodiments, once a threshold scale is reached, continuing to zoom in does not additionally increase the perspective; similarly, once a threshold zoomed-out scale is reached, the map continues to be displayed in a two-dimensional flat appearance.

### BRIEF DESCRIPTION OF THE DRAWING

FIG. 1 is a block diagram of a system for providing a gradually changing perspective map in accordance with an embodiment of the present invention.

FIG. 2 illustrates a viewer's eye and reference points for creating perspective views of a flat map in accordance with an embodiment of the present invention.

FIG. 3 illustrates projecting a point in association with creating perspective views of a flat map in accordance with an embodiment of the present invention.

FIG. 4 illustrates parameterizing the projection in association with creating perspective views of a flat map in accordance with an embodiment of the present invention.

FIG. 5 illustrates mapping of points between the virtual screen and the actual screen in accordance with an embodiment of the present invention.

FIG. 6 illustrates the use of an angle of depression in association with creating perspective views of a flat map in accordance with an embodiment of the present invention.

FIG. 7 illustrates a reparameterization performed in association with creating perspective views of a flat map in accordance with an embodiment of the present invention.

FIG. 8 illustrates a projection from a three-dimensional space in association with creating perspective views of a flat map in accordance with an embodiment of the present invention.

FIG. 9 is a flowchart illustrating a method for creating perspective views of a flat map in accordance with an embodiment of the present invention.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

The present invention comprises a system and method for displaying maps that transition gradually between a perspective view and a two-dimensional view. This avoids the jarring user experience that otherwise occurs in systems where the display changes abruptly from perspective to two-dimensional, or vice versa.

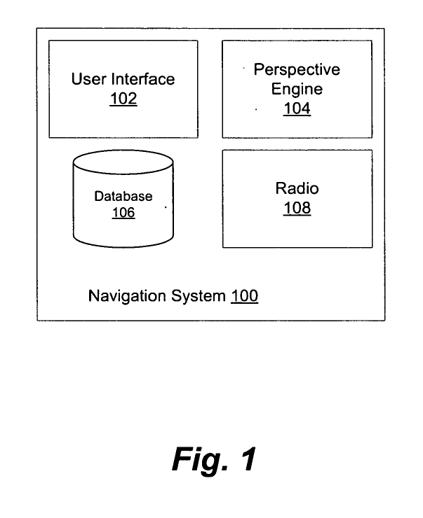

FIG. 1 is a block diagram of a navigation system 100 for providing a gradually changing perspective map in accordance with an embodiment of the present invention. Navigation system 100 includes a user interface 102, for providing output to and receiving input from a user, and a perspective engine 104, for adjusting the displayed perspective of the map in accordance with the description set forth here. System 100 also includes a database 106 for storing map-related data, and optionally a global navigation satellite system radio 108, for example a GPS receiver, used to identify a position of the navigation system 100. Navigation system 100 also includes additional modules and components necessary for performing various navigation functions, but which are not germane to this description and are therefore not illustrated here.

There is a correspondence between display scales (zoom levels) and the perspective view. Accordingly, we begin with a description of the mathematics of a perspective projection.

### Geometric Model

As noted, the goal in this portion of our description is to draw so-called “2½-dimensional” maps, i.e., perspective views of flat maps in a valid, aesthetically pleasing way.

We assume the initial existence of the map as a two-dimensional map, scaled appropriately, on a “virtual screen”. We define a “reference point” on the virtual screen. All coordinates in the virtual screen will be measured relative to this reference point. That is, we consider the reference point to have coordinates (0, 0) in the virtual screen.

We also define a reference point in the screen to be drawn, which we call the “actual screen”, or, when there is no confusion, just the “screen”. We also measure coordinates in the actual screen relative to the reference point. That is, we consider the reference point to have coordinates (0, 0) in the actual screen, with x increasing to the right and y increasing in the upward direction.

Note that the coordinate system for the actual screen is likely not the coordinate system that the graphics package will be using for the actual screen in implementing the described invention. Our reference point will usually be at or near the center of the screen, for reasons described below. At the implementation level, the origin in the graphics package's model of the screen is usually in either the upper left or the lower left corner. Also, a graphics package often considers y to increase in the downward direction. It remains up to the implementer to convert between these two coordinate systems, which is a very easy task.

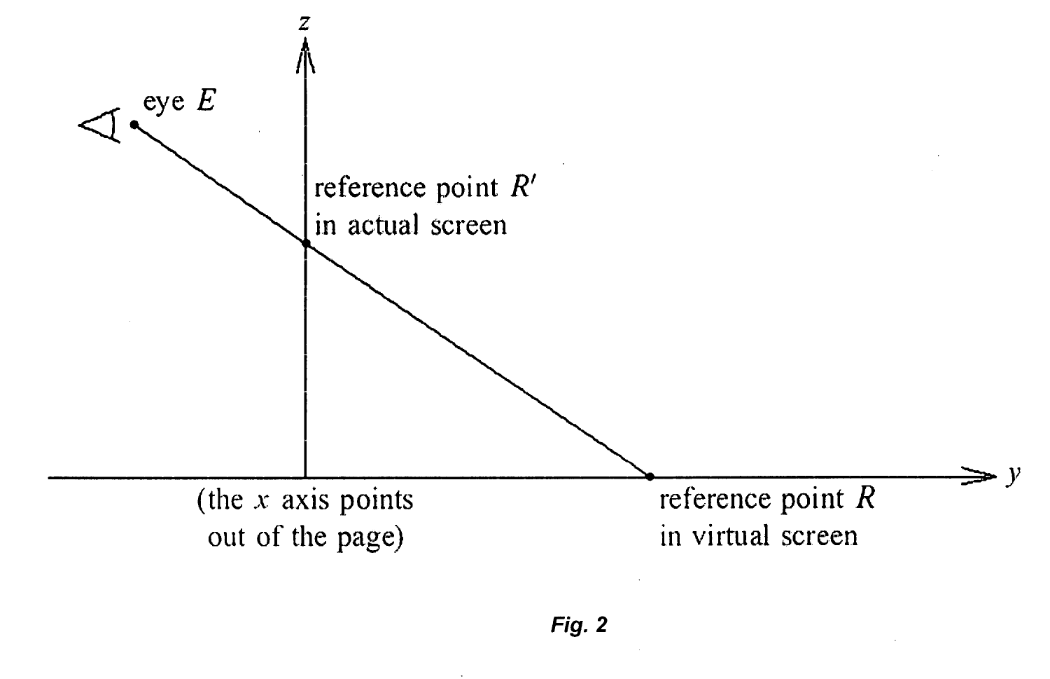

We construct the projection as follows: place the virtual screen, the actual screen, and the viewer's eye in a three-dimensional coordinate system, as illustrated in FIG. 2. The virtual screen is in the xy plane, with its x and y axes oriented parallel to the x and y axes of the three-dimensional coordinate system but with its reference point located at a point R on the positive y axis. The actual screen is in the xz plane, with its x and y axes oriented parallel to the x and z axes, respectively, and with its reference point located at a point R′ on the positive z axis. The viewer's eye is located at a point E in the yz plane somewhere behind the actual screen, placed so that the reference points in the virtual and actual screens are collinear. Note that the x axis points out of the page in FIG. 2.

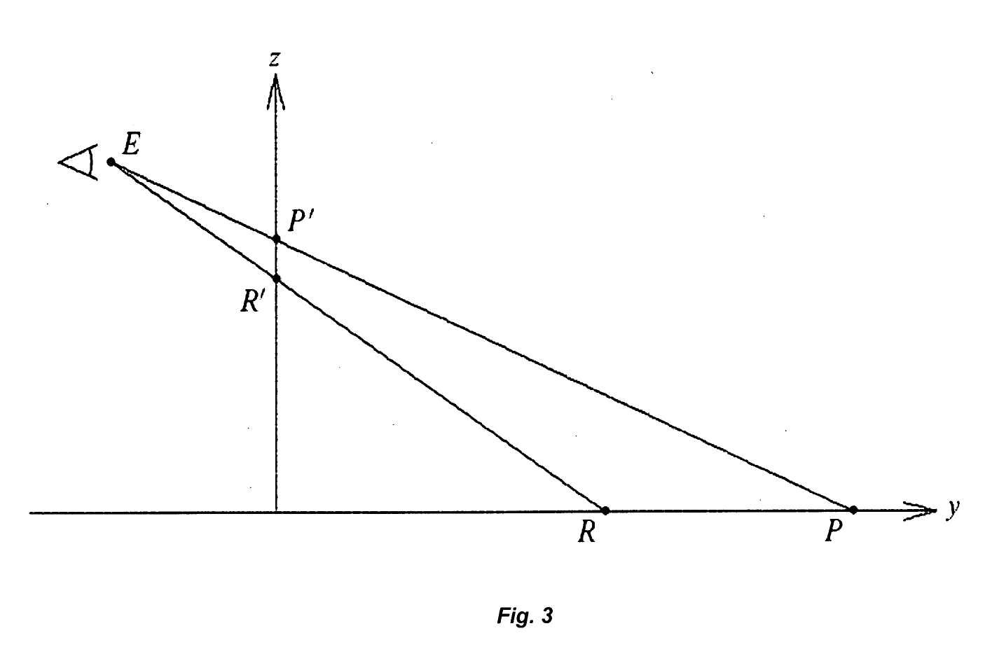

The projection is then constructed as follows: For any point P in the virtual screen, we construct a line from P to E. We then project P to the point P′ at which this line intersects the actual screen (the xz plane). FIG. 3 illustrates this.

Parameterization

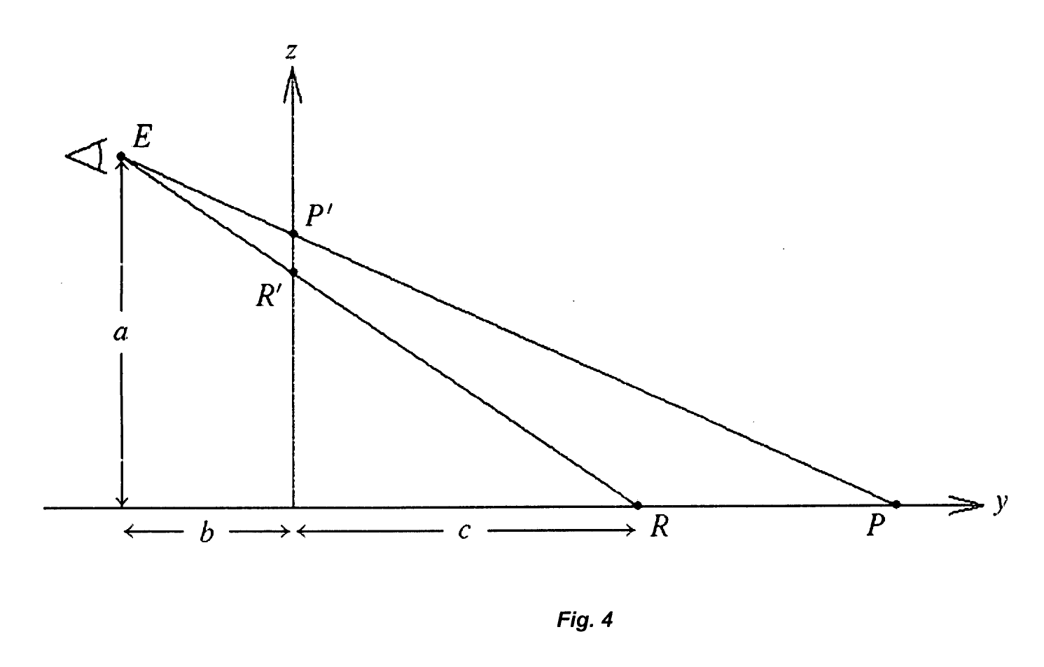

Referring to FIG. 4, there are three degrees of freedom: The distance a of the viewer's eye above the plane of the virtual screen, the distance b of the viewer's eye behind the actual screen, and the distance c from the plane of the actual screen to the reference point of the virtual screen. Specifying these parameters determines the position of the reference point of the actual screen in the three-dimensional coordinate system.

This places E at (0, −b, a), R at (0, c, 0), and R′ at (0, 0, z), for some unknown z, in the three-dimensional coordinate system. For brevity, henceforth we consider any set of three coordinates to be in the three-dimensional coordinate system, and any set of two coordinates to be in the coordinate system of the appropriate screen. Next we find the location of the reference point in the actual screen.

A basic observation in working out this and almost everything else about the perspective projection is that, for collinear points, the differences between the coordinates of pairs of the points are proportional. That is, if P₀=(x₀, y₀, z₀), P₁=(x₁, y₁, z₁), and P₂=(x₂, y₂, z₂) are collinear, we know that

$$\frac{{x}_{2} - {x}_{0}}{{x}_{1} - {x}_{0}} = \frac{{y}_{2} - {y}_{0}}{{y}_{1} - {y}_{0}} = \frac{{z}_{2} - {z}_{0}}{{z}_{1} - {z}_{0}} \qquad ( 1 )$$

Since E=(0, −b, a), R=(0, c, 0), and R′=(0, 0, z) are collinear, we can use the y and z terms of this identity to see that

$$\frac{0 - ( - b )}{c - ( - b )} = \frac{z - a}{0 - a}$$

Solving for z:

$$\frac{z - a}{- a} = \frac{b}{b + c}$$

So that

$$z - a = \frac{- ab}{b + c}$$

Or

$$\begin{matrix}z = a - \frac{a b}{b + c} \\ = \frac{a b + a c - a b}{b + c} \\ = \frac{a c}{b + c}\end{matrix}$$

Now that we have located the reference point, the problem becomes one of mapping between an arbitrary point P=(x, y) in the virtual screen and its corresponding point P′=(x′, y′) in the actual screen. Because the reference points are offset with respect to the origin of the three-dimensional coordinate system, P is located at (x, y+c, 0) and P′ is located at

$$( {x}^{′} , 0 , {y}^{′} + \frac{a c}{b + c} ) .$$

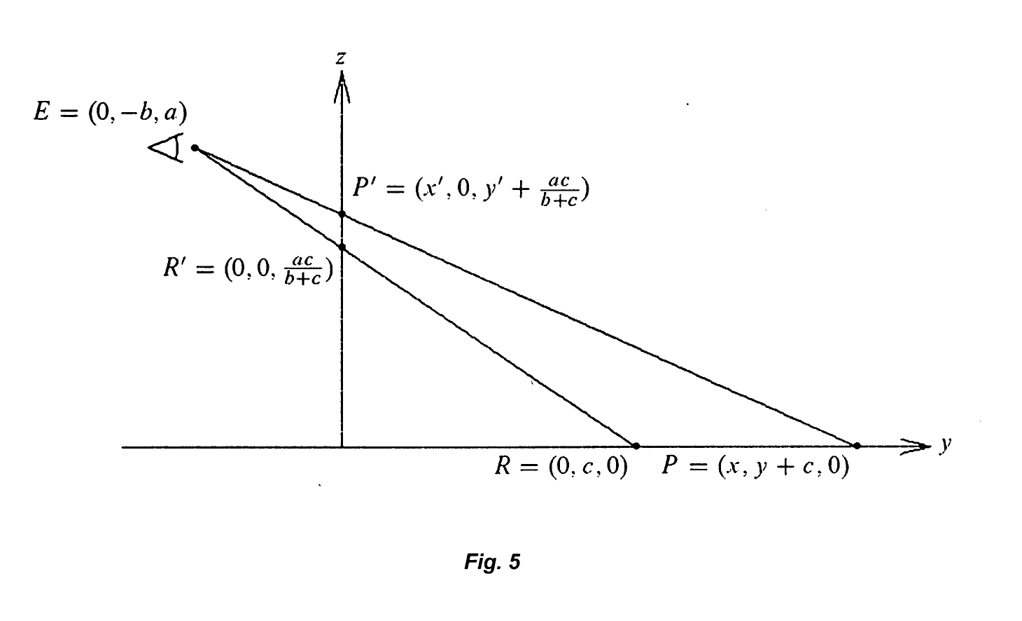

### See FIG. 5.

### The Fundamental Equation of the Projection

Because E, P, and P′ are collinear, we can use identity 1 above to determine that

$$\frac{{x}^{′} - 0}{x - 0} = \frac{0 - ( - b )}{y + c - ( - b )} = \frac{{y}^{′} + \frac{a c}{b + c} - a}{0 - a} \qquad ( 2 )$$

Simplifying the rightmost term:

$$\frac{{y}^{′} + \frac{a c}{b + c} - a}{0 - a} = \frac{{y}^{′} + \frac{a c - a b - a c}{b + c}}{- a} = \frac{{y}^{′} - \frac{a b}{b + c}}{- a} = \frac{b}{b + c} - \frac{{y}^{′}}{a}$$

So equation 2 simplifies to

$$\frac{{x}^{′}}{x} = \frac{b}{y + b + c} = \frac{b}{b + c} = \frac{{y}^{′}}{a} \qquad ( 3 )$$

This is the equation that we use to derive everything else about the projection.

Projecting from the Virtual Screen to the Actual Screen

To find the point P′=(x′, y′) in the actual screen that corresponds to a point P=(x, y) in the virtual screen, we have to determine x′ and y′ in terms of x and y.

From equation 3, we know that

$$\frac{{x}^{′}}{x} = \frac{b}{y + b + c}$$

Solving for x′, we find that

$${x}^{′} = \frac{b x}{y + b + c} \qquad ( 4 )$$

Similarly, from equation 3, we know that

$$\frac{b}{b + c} - \frac{{y}^{′}}{a} = \frac{b}{y + b + c}$$

Solving for y:

$$\begin{matrix}\frac{{y}^{′}}{a} = \frac{b}{b + c} - \frac{b}{y + b + c} \\ = \frac{b ( y + b + c ) - b ( b + c )}{( b + c ) ( y + b + c )} \\ = \frac{b y + {b}^{2} + b c - {b}^{2} - b c}{( b + c ) ( y + b + c )} \\ = \frac{b y}{( b + c ) ( y + b + c )}\end{matrix}$$

Or

$${y}^{′} = \frac{a b y}{( b + c ) ( y + b + c )} \qquad ( 5 )$$

Projecting from the Actual Screen to the Virtual Screen

Conversely, to find the point P=(x, y) in the virtual screen that corresponds to a point P′=(x′, y′) in the actual screen, we have to determine x and y in terms of x′ and y′.

From equation 3, we know that

$$\frac{{x}^{′}}{x} = \frac{b}{b + c} - \frac{{y}^{′}}{a}$$

Solving for x, we find that

$$x = \frac{{x}^{′}}{\frac{b}{b + c} - \frac{{y}^{′}}{a}} = \frac{a ( b + c )}{a b - ( b + c ) {y}^{′}} {x}^{′} \qquad ( 6 )$$

There are other ways to express the right-hand side of equation 6, but it's not clear that any of them are simpler.

To find y in terms of y′, we observe from equation 3 that

$$\frac{b}{y + b + c} = \frac{b}{b + c} - \frac{{y}^{′}}{a} \qquad ( 7 )$$

Solving for y:

$$\frac{y + b + c}{b} = \frac{1}{\frac{b}{b + c} - \frac{{y}^{′}}{a}}$$

Or

$$\begin{matrix}y = \frac{b}{\frac{b}{b + c} - \frac{{y}^{′}}{a}} - ( b + c ) \\ = \frac{b ( b + c ) a}{a b - ( b + c ) {y}^{′}} - ( b + c ) \\ = \frac{a b ( b + c ) - a b ( b + c ) + {( b + c )}^{2} {y}^{′}}{a b - ( b + c ) {y}^{′}} \\ = \frac{{( b + c )}^{2} {y}^{′}}{a b - ( b + c ) {y}^{′}} \\ = \frac{( b + c ) {y}^{′}}{\frac{a b}{b + c} - {y}^{′}}\end{matrix} \qquad ( 8 )$$

### Expressing the Parameterization in Useful Terms

Now that the conversions above are known, we can set a, b, and c in order make the projection on the actual screen look as desired. The person requesting the map does not care about a, b, and c—she cares about things like the scale, the amount of foreshortening, and the location of the horizon. So, we proceed to specify a, b, and c in terms of those quantities.

### Scale

The scale for the projected map can be specified by specifying the horizontal scale at the reference point R′. In order to know the scale at which to draw the map on the virtual screen, we have to know the relationship between the scale on the actual screen and the scale on the virtual screen at R′. In other words, we need to know the relative scale r₀=∂x′/∂x at R′.

This value can be derived. From equation 3, we know that

$$\frac{{x}^{′}}{x} = \frac{b}{y + b + c}$$

That is,

$${x}^{′} = \frac{bx}{y + b + c}$$

Differentiate with respect to x:

$$\frac{\partial {x}^{′}}{\partial x} = \frac{b}{y + b + c} \qquad ( 9 )$$

But at R′, y=0, so

$$\frac{\partial {x}^{′}}{\partial x} = \frac{b}{y + b + c} \qquad ( 10 )$$

Once we have this relative scale r₀, we determine the scale at which to draw the map on the virtual screen by taking the horizontal scale desired at the reference point and dividing it by r₀. For example, to obtain a horizontal scale of 100 pixels/km at the reference point, we render the map on the virtual screen at a scale of 100/r₀ pixels/km.

### Foreshortening

Specifying the scale is not enough to specify the appearance of the map. Even once the horizontal scale is fixed at the reference point, we can make the map look more or less foreshortened by moving the viewer's eye more or less far behind the screen, i.e. by making b larger or smaller.

Of course, specifying the location of the viewer's eye is not at all intuitive to someone requesting a map. What is likely to be much more intuitive is specifying a “foreshortening ratio”. We define the “foreshortening ratio” at a point—for example, at the reference point—to be the ratio of the vertical scale to the horizontal scale at that point. For example, a small circle on the virtual screen centered at the reference point will be projected to an ellipse on the actual screen (almost) centered at the reference point, with its axes parallel to the x′ and y′ axes. The foreshortening ratio is the ratio of the length of the vertical axis of the ellipse to the length of its horizontal axis. Mathematically, the foreshortening ratio at any point is

$$f = \frac{\partial {y}^{′} / \partial y}{\partial {x}^{′} / \partial x} .$$

Let the foreshortening ratio at the reference point be called f₀.

To apply a specified foreshortening ratio, we need to be able to find ∂y′/∂y at a specified point. From equation 3, we know that

$$\frac{b}{b + c} - \frac{{y}^{′}}{a} = \frac{b}{y + b + c}$$

Differentiating both sides with respect to y, we find that

$$- \frac{1}{a} \frac{\partial {y}^{′}}{\partial y} = - \frac{b}{{( y + b + c )}^{2}}$$

That is,

$$\frac{\partial {y}^{′}}{\partial y} = - \frac{ab}{{( y + b + c )}^{2}} \qquad ( 11 )$$

But at the reference point, y=0, so that at the reference point

$$\frac{\partial {y}^{′}}{\partial y} = - \frac{b}{{( b + c )}^{2}}$$

Combining this with equation 10, we find that

$$\begin{matrix}{f}_{0} = \frac{\partial {y}^{′} / \partial y}{\partial {x}^{′} / \partial x} \\ = \frac{{ab ( b + c )}^{2}}{b / ( b + c )} \\ = \frac{a}{b + c}\end{matrix}$$

### Angle of Depression

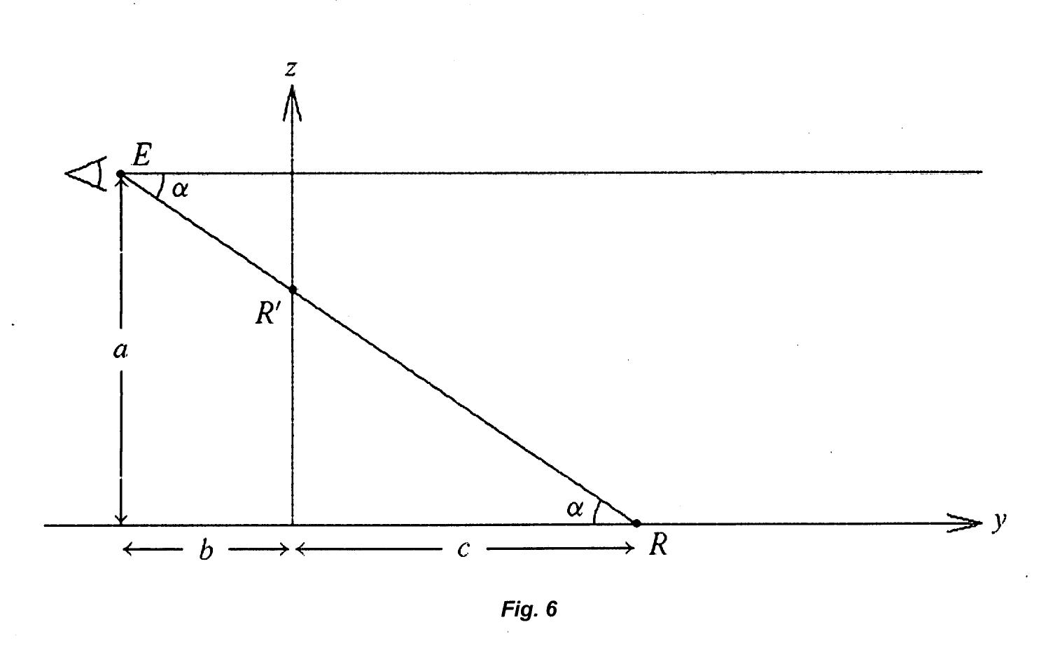

Some implementers may want to think in terms of an “angle of depression” α, the angle between the line from the viewer's eye E to the horizon and the line from E to the reference point R in the virtual screen, as illustrated in FIG. 6.

Because this is also the angle between the line from E to R and the negative direction of y axis, it's easy to see that tan α=a/(b+c)=f₀, the foreshortening ratio. So α=arctan f₀. Because the implementer can easily use these conversions, henceforth we will discuss only the foreshortening ratio.

### Location of the Horizon

Given a, b, and c, the location of the horizon on the actual screen can be determined. The horizon is at the level of the viewer's eye. Its height above the reference point is therefore

$$\begin{matrix}h = a - \frac{ac}{b + c} \\ = \frac{ab + ac - ac}{b + c} \\ = \frac{ab}{b + c}\end{matrix}$$

Doing Away with Relative Scale

So far we have determined the relative scale r₀, foreshortening ratio f₀, and height h of the horizon in terms of a, b, and c:

$${r}_{0} = \frac{b}{b + c} \\ {f}_{0} = \frac{a}{b + c} \\ h = \frac{ab}{b + c} \qquad ( 12 )$$

But one of these things is not like the others. The person requesting the map really cares about the actual scale (pixels per unit distance), not the relative scale (pixels on the actual screen per pixel on the virtual screen). After all, we can always rescale the map drawn on the virtual screen appropriately. So far, therefore, we have two values f₀ and h to set in order to specify a, b, and c.

This means that either (1) there is another degree of freedom in the appearance of the map that the user can specify, or else (2) there is redundancy in the values of a, b, and c, and we can specify one of them at our whim and still produce a map with the same appearance. In the latter case, then we can specify a value of, for example, c and a different scale in the virtual screen, and obtain exactly the same projection on the actual screen.

To illustrate, fix values for â, \hat{b}, and ĉ, then specify a, b, and c in such a way that the relative scale \hat{r}₀=1 but such that the foreshortening ratio and the height of the horizon remain unchanged. We then rescale x and y appropriately, and see whether the projection comes out the same. If it does, that will indicate that we can set relative scale any way we like.

If

$${\hat{r}}_{0} = \frac{\hat{b}}{\hat{b} + \hat{c}} = 1 ,$$

that forces ĉ=0. To keep the height of the horizon the same, we have to set ĥ=h, i.e.,

$$\frac{ab}{b + c} = \frac{\hat{a} \hat{b}}{\hat{b} + \hat{c}} = \frac{\hat{a} \hat{b}}{\hat{b}} = \hat{a}$$

That determines the value of â.

To keep the foreshortening ratio \hat{f}₀=f₀, we must set

$$\frac{ab}{b + c} = \frac{\hat{a}}{\hat{b} + \hat{c}} = \frac{\hat{a}}{\hat{b}}$$

Solving for b,

$$\hat{b} = \frac{( b + c )}{a} \hat{a} = \frac{b + c}{a} \frac{ab}{b + c} = b$$

To summarize: We define a new mapping with the parameters

$$\hat{a} = \frac{ab}{b + c}$$

$$\hat{b} = b$$

$$\hat{c} = c$$

We rescale the coordinates in the virtual screen by the original relative scale:

$$\hat{x} = \frac{b}{b + c} x$$

$$\hat{y} = \frac{b}{b + c} y$$

Then we apply the mapping to get a new \hat{x}′ and ŷ′. If they are the same as the original x′ and y′, then the mappings really are the same.

From equation 5, we know that

$$\begin{matrix}{\hat{x}}^{′} = \frac{\hat{b} \hat{x}}{\hat{y} + \hat{b} + \hat{c}} \\ = \frac{b \frac{b}{b + c} x}{\frac{b}{b + c} y + b + 0} \\ = \frac{{b}^{2} x}{b y + b ( b + c )} \\ = \frac{b x}{y + b + c}\end{matrix}$$

So the mapping of x to x′ matches. Now check the mapping of y. From equation 5, we know that

$$\begin{matrix}{\hat{y}}^{′} = \frac{\hat{a} \hat{b} \hat{y}}{( \hat{b} + \hat{c} ) ( \hat{y} + \hat{b} + \hat{c} )} \\ = \frac{\frac{a b}{b + c} b \frac{b}{b + c} y}{( b + 0 ) ( \frac{b}{b + c} y + b + 0 )} \\ = \frac{\frac{a {b}^{3} y}{{( b + c )}^{2}}}{{b}^{2} ( \frac{y}{b + c} + 1 )} \\ = \frac{\frac{a b y}{{( b + c )}^{2}}}{\frac{y}{b + c} + 1} \\ = \frac{\frac{a b y}{{( b + c )}^{2}}}{\frac{y + b + c}{b + c}} \\ = \frac{a b y}{( b + c ) ( y + b + c )}\end{matrix}$$

So the mapping of y to y′ matches as well.

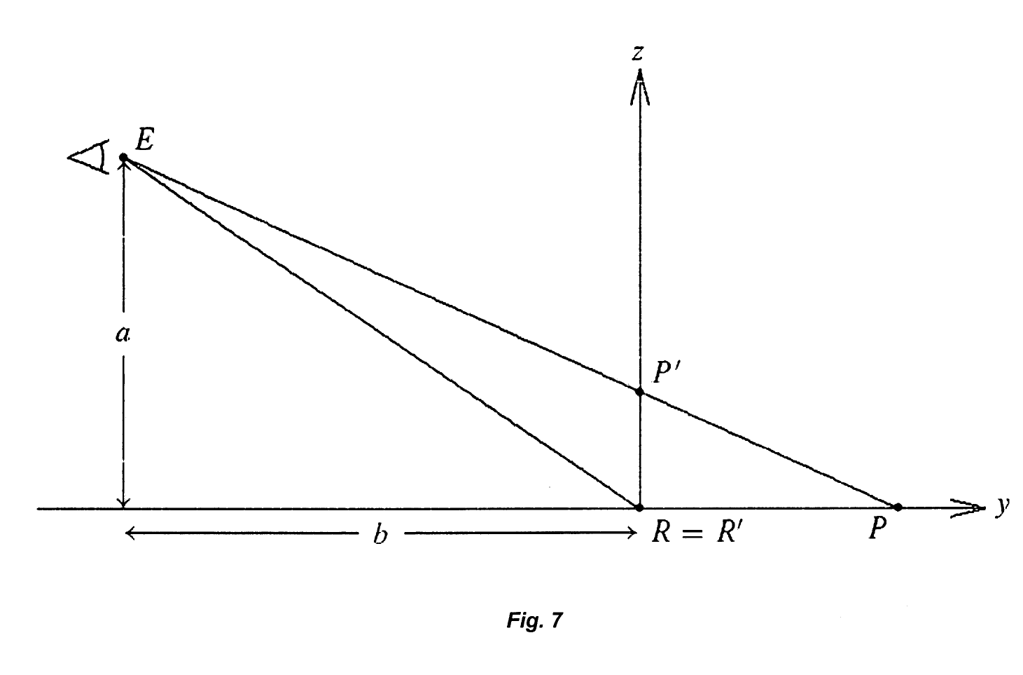

If we use this reparameterization, with c=0, the picture actually ends up looking like that illustrated in FIG. 7 instead.

We have seen that the only degrees of freedom that we have in formulating the final mapping are the height of the horizon h and the foreshortening ratio f₀, and that we can safely set c=0. That turns the relations in equations 12 into

r₀=1

f₀=a/b

h=a

Or, stating a and b in terms of f₀ and h instead:

a=h

b=h/f₀ (13)

c=0

We can now express x′ and y′ in terms of x, y, h, and f₀. From equations 4 and 5:

$$\begin{matrix}\begin{matrix}{x}^{′} = \frac{b x}{y + b + c} \\ = \frac{\frac{h x}{{f}_{0}}}{y + \frac{h}{{f}_{0}}} \\ = \frac{h x}{{f}_{0} y + h}\end{matrix} & ( 14 ) \\ \begin{matrix}{y}^{′} = \frac{a b y}{( b + c ) ( y + b + c )} \\ = \frac{a b y}{b ( y + b )} \\ = \frac{a y}{y + b} \\ = \frac{h y}{y + \frac{h}{{f}_{0}}} \\ = \frac{{f}_{0} h y}{{f}_{0} y + h}\end{matrix} & ( 15 )\end{matrix}$$

We can determine the inverse relations by solving directly, or by plugging into equations 6 and 8, as shown here:

$$\begin{matrix}\begin{matrix}x = \frac{ {x}^{′}}{\frac{b}{b + c} - \frac{{y}^{′}}{a}} \\ = \frac{ {x}^{′}}{\frac{b}{b} - \frac{{y}^{′}}{h}} \\ = \frac{ {x}^{′}}{1 - \frac{{y}^{′}}{h}} \\ = \frac{h {x}^{′}}{h - {y}^{′}}\end{matrix} & ( 16 ) \\ \begin{matrix}y = \frac{( b + c ) {y}^{′}}{\frac{a b}{b + c} - {y}^{′}} \\ = \frac{ b {y}^{′}}{\frac{a b}{b} - {y}^{′}} \\ = \frac{b {y}^{′}}{a - {y}^{′}} \\ = \frac{\frac{h }{{f}_{0}} {y}^{′}}{h - {y}^{′}} \\ = \frac{h {y}^{′}}{{f}_{0} ( h - {y}^{′} )}\end{matrix} & ( 17 )\end{matrix}$$

### Alternative Reparameterizations

Although parameterizing the projection in terms of the height h of the horizon above the reference point is useful and intuitive if the horizon is on the screen, it is sometimes desirable to use a different parameter when the screen layout is designed in such a way that the horizon is off the screen. We describe two alternatives to h.

### Rate of Change of Foreshortening

The location of the horizon determines how quickly the foreshortening ratio changes with respect to the screen coordinate y′. Even when the horizon is not visible, the rate of change q of the foreshortening ratio with respect to y′ at the reference point is visible on the screen.

Determine the relationship between that rate of change q and f₀ and h. From equation 15, we know that

$${y}^{′} = \frac{{f}_{0} h y}{{f}_{0} y + h}$$

Partially differentiating with respect to y,

$$\begin{matrix}\frac{\partial {y}^{′}}{\partial y} = \frac{( {f}_{0} y + h ) ( {f}_{0} h ) - ( {f}_{0} h y ) ( {f}_{0} )}{{( {f}_{0} y + h )}^{2}} \\ = \frac{{f}_{0} {h}^{2}}{{( {f}_{0} y + h )}^{2}}\end{matrix}$$

From equation 14, we know that

$${x}^{′} = \frac{h x}{{f}_{0} y + h}$$

Partially differentiating with respect to x,

$$\frac{\partial {x}^{′}}{\partial x} = \frac{h}{{f}_{0} y + y}$$

As a result, in terms of f₀, h, and y, at any point the foreshortening ratio is

$$\begin{matrix}f = \frac{\partial {y}^{′} / \partial y}{\partial x / \partial x} \\ = \frac{{f}_{0} {h}^{2} / ( {f}_{0} y + {h}^{2}}{h / ( {f}_{0} y + h} \\ = \frac{{f}_{0} h}{{f}_{0} y + h}\end{matrix}$$

However, to determine q=df/dy′, we need to express f in terms of y′. Using equation 17 to substitute for y,

$$\begin{matrix}f = \frac{{f}_{0} h}{{f}_{0} ( \frac{h {y}^{′}}{{f}_{0} ( h - {y}^{′} )} ) + h} \\ = \frac{{f}_{0} h}{\frac{h {y}^{′}}{h - {y}^{′}} + h} \\ = \frac{{f}_{0} h ( h - {y}^{′}}{h {y}^{′} + h ( h - {y}^{′} )} \\ = \frac{{f}_{0} h ( h - {y}^{′} )}{{h}^{2}} \\ = \frac{{f}_{0} ( h - {y}^{′} )}{h} \\ = {f}_{0} - \frac{{f}_{0} {y}^{′}}{h}\end{matrix}$$

As a result, it's easy to differentiate f with respect to y′:

$$q = \frac{d f}{d {y}^{′}} = - \frac{{f}_{0}}{h}$$

It is therefore possible to parameterize the projection in terms of f₀ and q instead of in terms of f₀ and h, by setting h=−f₀/q.

### Vanishing Point Angle

Another parameter that is useful in specifying a perspective view when the horizon is off the screen is the “vanishing point angle”. Imagine a straight line in the virtual screen (for example, a straight street) pointing directly from the reference point to the horizon. This line will have constant x=0 in the virtual screen, and x′=0 in the actual screen. Now consider another straight line, parallel to the first, which is projected onto the screen so that it hits the left edge of the screen at y′=0, i.e., on a level with the reference point. This projected line will make an angle with the edge of the screen that becomes smaller and smaller as the horizon moves farther and farther up (i.e., as h becomes greater and greater). We can specify the projection using this “vanishing point angle” φ.

It is possible to determine the relation between φ and h. Let the width of the screen be w. Consider the triangle formed by the left edge of the screen, the horizon, and the projected line. The top edge of the triangle—the part of the horizon between the extension of the left edge of the screen and the extension of the projected line—has length w/2. The left edge of the triangle—the extension of the left edge of the screen from the level of the reference point to the horizon—has length h. The angle between the left edge and the hypotenuse is φ. As a result,

$$tan φ = \frac{w / 2}{h}$$

So that

$$h = \frac{w}{2 tan φ}$$

Projecting from Three Dimensions

Sometimes we want to project from a three-dimensional space, rather than a plane, onto the screen. From the projection from the plane, the extension to three dimensions is straightforward.

As noted, we can, without loss of generality, set c=1 and thereby set the relative scale r₀=1. That will make the algebra of the projection from three dimensions much simpler.

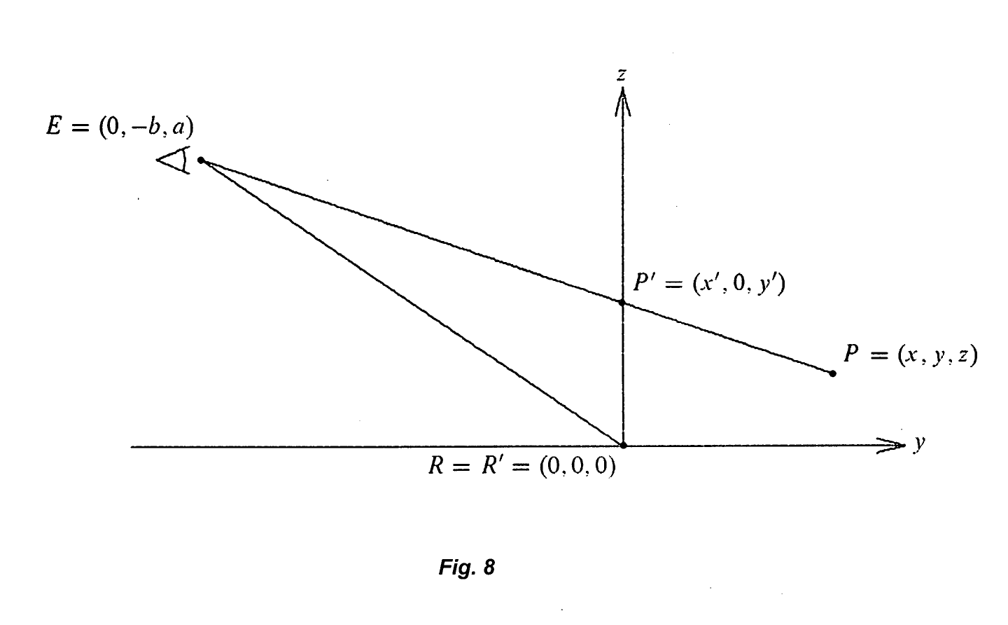

Refer now to FIG. 8. Suppose P is at (x, y, z) relative to the reference point R=(0,0,0). This puts P at (x, y, z) in the three-dimensional coordinate space as well.

Setting c=0 and using (x, y, z) instead of (x, y+c, 0) as the coordinates of P, equation 2 turns into

$$\frac{{x}^{′} - 0}{x - 0} = \frac{0 - ( - b )}{y - ( - b )} = \frac{{y}^{′} - a}{z - a}$$

Simplifying, this becomes

$$\frac{{x}^{′}}{x} = \frac{b}{y + b} = \frac{{y}^{′} - a}{z - a} \qquad ( 18 )$$

Solving for x′ and y′, we find that

$${x}^{′} = \frac{bx}{y + b} \qquad ( 19 )$$

—which is unchanged from before—and that

$${y}^{′} - a = \frac{b ( z - a )}{y + b}$$

so that

$$\begin{matrix}{y}^{′} = a + \frac{b ( z - a )}{y + b} \\ = \frac{a ( y + b )}{y + b} + \frac{b ( z - a )}{y + b} \\ = \frac{ay + ab + bz - ab}{y + b} \\ = \frac{ay + bz}{y + b}\end{matrix} \qquad ( 20 )$$

If we want to express the projection equations in terms of h and f₀ instead of in terms of a and b, we can use equations 13, which turns equations 19 and 20 into

$$\begin{matrix}{x}^{′} = \frac{\frac{hx}{{f}_{0}}}{y + \frac{h}{{f}_{0}}} \\ = \frac{hx}{fy + h}\end{matrix}$$

$$and$$

$$\begin{matrix}{y}^{′} = \frac{hy + \frac{hz}{{f}_{0}}}{y + \frac{h}{{f}_{0}}} \\ = \frac{fhy + hz}{fy + h}\end{matrix}$$

Unfortunately, when it comes to performing the reverse projection from (x′, y′) in the actual screen to (x, y, z) relative to the virtual screen, there is insufficient information to determine x, y, and z. Solving equation 19 for x, y, and z amounts to solving two equations in three unknowns. We can do it if we know one of x, y, and z, but not otherwise.

### Aesthetic Considerations

It is possible to define a, b, and c (or alternatively r₀, h, and f₀), so that the foreshortening ratio at the bottom of the screen becomes greater than 1, that is, so that a tiny circle on the virtual screen is elongated into an ellipse with the long axis vertical. Many viewers find this unattractive and puzzling. It is therefore advisable to set the projection parameters so that the foreshortening ratio remains less than 1 even at the bottom of the screen.

From equations 9 and 11, the partial derivatives

$$\frac{\partial {x}^{′}}{\partial x} and \frac{\partial {y}^{′}}{\partial y}$$

at a general point are

$$\frac{\partial {y}^{′}}{\partial y} = \frac{ab}{{( y + b + c )}^{2}}$$

$$\frac{\partial {x}^{′}}{\partial x} = \frac{b}{y + b + c}$$

This means that the foreshortening ratio f at a general point is

$$\begin{matrix}f = \frac{\partial {y}^{′} / \partial y}{\partial {x}^{′} / \partial x} \\ = \frac{( ab ) / {( y + b + c )}^{2}}{( b ) / ( y + b + c )} \\ = \frac{a}{y + b + c} .\end{matrix}$$

But we need this in terms of y′. Fortunately, we know from equation 7 that

$$\frac{b}{y + b + c} = \frac{b}{b + c} - \frac{{y}^{′}}{a}$$

So at a general point

$$\begin{matrix}f = \frac{a}{y + b + c} \\ = \frac{a}{b} \frac{b}{y + b + c} \\ = \frac{a}{b} ( \frac{b}{b + c} - \frac{{y}^{′}}{b} \\ = \frac{a}{b + c} - \frac{{y}^{′}}{b}\end{matrix}$$

We would like to find the values of y′ for which f<1. Solving the inequality for y′ yields

$${y}^{′} > \frac{ab}{b + c} - b$$

We also need to express this condition in terms of h and f₀ for the projection parameterized by those values. Using equations 13, the inequality above becomes

$${y}^{′} > \frac{h \frac{h}{{f}_{0}}}{\frac{h}{{f}_{0}} + 0} - \frac{h}{{f}_{0}} = h - \frac{h}{{f}_{0}}$$

For aesthetic purposes, a, b, and c, or alternatively h and f₀, should be set so that the coordinate y′ at the bottom of the actual screen satisfies the appropriate inequality above.

### Summary for Rendering Perspective View

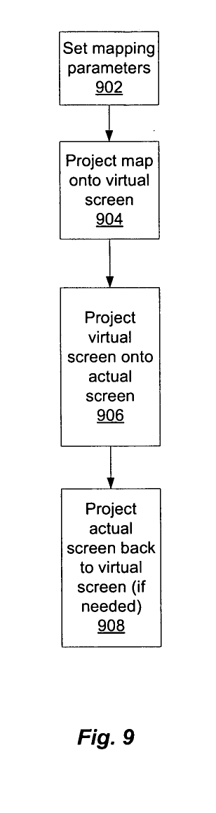

To summarize the discussion above, and with reference to FIG. 9, we again specify steps taken in an embodiment to render a perspective view of a two-dimensional map.

First, set 902 the mapping parameters. Specify the foreshortening ratio f₀ at the reference point and the height h of the horizon above the reference point on the screen.

Next, project 904 the map onto the virtual screen. Use the scale, in pixels/km or whatever units are desired, to be applied at the reference point on the screen. Orient the map with the positive y axis pointing in whatever compass direction to be at the top of the screen. Place the longitude and latitude meant to be at the reference point at the origin (0, 0) of the virtual screen.

Next, project 906 the virtual screen onto the actual screen. For each point (x, y) on the virtual screen, find the corresponding point (x′, y′) on the actual screen using equations 14 and 15, repeated here:

$${x}^{′} = \frac{hx}{fy + h}$$

$${y}^{′} = \frac{fhy}{fy + h}$$

If necessary, project 908 the actual screen back to the virtual screen. It may be necessary to map coordinates (x′, y′) on the actual screen—for example, points selected with mouse clicks—back into coordinates (x, y) on the virtual screen using equations 16 and 17, repeated below:

$$x = \frac{{hx}^{′}}{h - {y}^{′}}$$

$$y = \frac{{hy}^{′}}{{f}_{0} ( h - {y}^{′} )}$$

In one embodiment, the navigation system 100 displays maps using only a fixed set of scales, and there is a fixed perspective view corresponding to each scale. That is, there is a table of the following form:

| Scale at | Foreshortening ratio | Rate of change of |
|---|---|---|
| reference point | at reference point | foreshortening |
| (pixels/meter) | (dimensionless) | (inverse pixels) |
| 4 | 0.5 | −0.005 |
| 2 | 0.5 | −0.005 |
| 1 | 0.5 | −0.005 |
| 1/2 | 0.52 | −0.0048 |
| 1/4 | 0.54 | −0.0046 |
| 1/8 | 0.56 | −0.0044 |
| . . . | . . . | . . . |
| 1/(8.39 × 10⁶) | 0.96 | −0.0004 |
| 1/(1.68 × 10⁷) | 0.98 | −0.0002 |
| 1/(3.36 × 10⁷) | 1 | 0 |
| 1/(6.71 × 10⁷) | 1 | 0 |
| 1/(1.34 × 10⁸) | 1 | 0 |
| . . . | . . . | . . . |

Note that a foreshortening of 1 and a rate of change of foreshortening of 0 denotes a two-dimensional, i.e., straight-down view. The usual formulas for a perspective projection break down at these values, but the view is simply the standard straight-down view known to practitioners of the art.

There is no special preference for the values shown above. Rather, the above table is meant to exemplify the properties that the progression of values might have. For example, in one embodiment perspective engine 104 uses a scale such that at all scales less than that scale the perspective parameters are the same. Similarly, in one embodiment there is a scale such that at all scales greater than that scale the perspective parameters remain the same. In one embodiment, between those scales the foreshortening and the rate of change of foreshortening change in a regular manner. It is often aesthetically pleasing to have both parameters change linearly as a function of the logarithm of the scale.

In various embodiments, the navigation system 100 does not have a fixed set of scales at which it displays maps, but rather a continuum of scales. In some such embodiments, the parameters are specified as functions of the scale rather than as values in a table. For example, the parameters might be specified as follows:

| | ... then the | |
|---|---|---|
| | foreshortening ratio | . . . and the rate |
| If the scale s at the | at the reference point | of change of |
| reference point is . . . | is . . . | foreshortening is . . . |
| >1 pixel/meter | 0.5 | −0.005 pixel⁻¹ |
| between 2⁻²⁵ pixel/meter | 0.5-0.02 log₂ s | −0.0005-0.0002 |
| and 1 pixel/meter | | log₂ s pixel⁻¹ |
| <2⁻²⁵ pixel/meter | 1 | 0 |

In some embodiments, the progression of the projection values for the various map scales, whether a discrete set or a continuum, is fixed and not alterable as part of the user interface 102. In other embodiments, the user interface 102 allows the user to change the way in which the gradual change of projection values is accomplished.

While the present invention has been described above in particular detail with respect to a limited number of embodiments, other embodiments are possible as well. The particular naming of the components and their programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components. For example, the particular functions of the perspective engine 104 may be provided in many or one module.

The operations described above, although described functionally or logically, may be implemented by computer programs stored on one or more computer readable media and executed by a processor. Computer readable storage media include, for example, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

Throughout the description, discussions using terms such as “processing” or “computing” or “calculating” or “determining” or “displaying” or the like, refer to the action and processes of a particular computer system, or similar electronic computing device, that manipulates and transforms data representing or modeling physical characteristics, and which is represented as physical (electronic) quantities within the computer system memories or registers or other such information storage, transmission or display devices.

The algorithms and displays presented above are not inherently related to any particular computer or other apparatus. Various general-purpose systems may also be modified by using the teachings herein, or it may prove convenient to construct more specialized apparatus to perform the described method steps. The required structure for a variety of these systems will appear from the description above. In addition, the present invention is not described with reference to any particular programming language, any suitable one of which may be selected by the implementer.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A method for displaying a digital map, the method comprising:
displaying a digital map on a display device according to a first view, the first view having a first scale and a first foreshortening ratio;
in response to a first request from a user, displaying the digital map on the display device according to a second view, the second view having a second scale larger than the first scale and a second foreshortening ratio less than the first foreshortening ratio; and
in response to a second request from the user, displaying the digital map on the display device according to a third view, the third view having a third scale larger than the second scale and a third foreshortening ratio less than the second foreshortening ratio.

2. The method of claim 1 wherein the third foreshortening ratio is 0.5.

3. The method of claim 1 further comprising:
in response to a third request from the user, displaying the digital map on the display device according to a fourth view, the fourth view having a fourth scale larger than the third scale, and having the third foreshortening ratio.

4. The method of claim 1 wherein the first foreshortening ratio is 1.

5. The method of claim 1 further comprising:
in response to a third request from the user, displaying the digital map on the display device according to a fourth view, the fourth view having a fourth scale smaller than the first scale, and having the first foreshortening ratio.

6. The method of claim 1 further comprising:
in response to a third request from the user, displaying the digital map on the display device according to a fourth view, the fourth view having a fourth scale larger than second scale and smaller than the third scale, and having a fourth foreshortening ratio less than the second foreshortening ratio and larger than the third foreshortening ratio.

7. A system for displaying a digital map, comprising:
a database storing at least one digital map;
a user interface, coupled to the database, adapted to display the digital map stored in the database at a plurality of scales and a plurality of foreshortening ratios; and
a perspective engine, coupled to the database and the user interface, adapted to select from at least three foreshortening ratios according to a desired scale, and to render the map at the desired scale with the selected foreshortening ratio for display in the user interface.

8. A computer program product for displaying a digital map, the computer program product stored on a computer-readable medium and including instructions to cause a computer to carry out the steps of:
displaying a digital map on a display device according to a first view, the first view having a first scale and a first foreshortening ratio;
in response to a first request from a user, displaying the digital map on the display device according to a second view, the second view having a second scale smaller than the first scale and a second foreshortening ratio larger than the first foreshortening ratio; and
in response to a second request from the user, displaying the digital map on the display device according to a third view, the third view having a third scale smaller than the second scale and a third foreshortening ratio larger than the second foreshortening ratio.
